(19) United States
(12) Patent Application Publication
(10) Pub. No.: US 2005/0285817 A1
(43) Pub. Date: Dec. 29, 2005

(54) Plasma display apparatus and method of driving the same

(75) Inventors: Sang Jin Yoon, Chilgok-gun (KR); Soo Seok Sim, Gumi-si (KR); Kwang Sun Sa, Uljin-gun (KR); Seong Ho Kang, Daegu (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/159,366

(22) Filed: Jun. 23, 2005

(30) Foreign Application Priority Data
Jun. 25, 2004 (KR) 10-2004-0048435

(51) Int. Cl. G09G 3/28

(52) U.S. Cl. 345/63

(57) ABSTRACT

Disclosed is a plasma display panel, and more particularly to, a plasma display apparatus for driving an address electrode and a method of driving a plasma display panel. The plasmas display apparatus comprises: a load calculator for calculating the data load of image data to be input to a plasma display panel from outside; and a gain controller for controlling the gain of image data according to the data load of image data calculated by the load calculator. A driving unit can be prevented from damage by reducing the magnitude of displacement current by controlling the gain according to the data load of image data.

This Nonprovisional application claims priority under 35 U.S.C. § 119(a) on Patent Application No. 10-2004-0048435 filed in Korea on Jun. 25, 2004 the entire contents of which are hereby incorporated by reference.

### BACKGROUND OF THE INVENTION

1. Field of the Invention

The present invention relates to a plasma display panel, and more particularly to, a plasma display apparatus for driving an address electrode and a method of driving a plasma display panel.

2. Description of the Background Art

Generally, a plasma display panel excites and radiates a phosphorus material using an ultraviolet ray generated upon discharge of an inactive mixture gas such as He+Xe or Ne+Xe, to thereby display a picture inclusive of characters or graphics.

FIG. 1 is a perspective view showing a structure of a general plasma display panel.

As shown in FIG. 1, the plasma display panel includes scan electrodes Y and 12A and sustain electrodes Z and 12B provided on an upper substrate 10, and address electrodes X and 20 provided on a lower substrate 18. Each of the scan electrodes 12A and the sustain electrodes 12B includes transparent electrodes and bus electrodes. The transparent electrodes are formed from indium-tin-oxide (ITO). The metal bus electrodes are formed from a metal for reducing a voltage drop.

On the upper substrate 10 provided with the scan electrode 12A and the common sustain electrode 12B, an upper dielectric layer 14 and a protective film 16 are disposed.

Wall charges generated upon plasma discharge are accumulated onto the upper dielectric layer 14. The protective film 16 prevents a damage of the upper dielectric layer 14 caused by a sputtering during the plasma discharge and improves the emission efficiency of secondary electrons. This protective film 16 is usually made from magnesium oxide (MgO).

A lower dielectric layer 22 and barrier ribs 24 are formed on the lower substrate 18 provided with the address electrode X. The surfaces of the lower dielectric layer 22 and the barrier ribs 24 are coated with a phosphorous material 26.

The address electrode X is formed in a direction crossing the scan electrode Y and the sustain electrode Z. The barrier rib 24 is formed in parallel to the address electrode X to thereby prevent an ultraviolet ray and a visible light generated by a discharge from being leaked to the adjacent discharge cells.

The phosphorous material 26 is excited by an ultraviolet ray generated during the plasma discharge to generate any one of red, green and blue visible light rays. An inactive mixture gas, such as He+Xe or Ne+Xe, for charging is injected into a discharge space of the discharge cell defined between the upper and lower substrate 10 and 18 and the barrier rib 24.

Driving apparatuses are coupled to the plasma display panel of such a structure, to form a plasma display apparatus.

FIG. 2 is a simple circuit diagram of a driving apparatus of the general plasma display panel.

As shown in FIG. 2, when a channel corresponding to a first scan electrode Y1 is selected in a scanning process, the channels corresponding to the other scan electrodes Y2, Y3 . . . Yn are not selected.

When a channel is selected as above, a second switching element 213-1 of a first scan deriver 210-1 corresponding to the selected channel is turned on and a scanning switching element 220 is turned on.

At the same time, first switching elements 211-2 to 211-n of scan drivers 210-2 to 210-n corresponding to unselected channels and a ground switching element 230 are turned on.

When the switching elements are operated and a data voltage +Vd or 0V is applied to address electrodes X1 to Xm by the operation of first data switching elements 310-1 to 310-m or second data switching elements 320-1 to 320-m of data drivers IC 3001- to 300-m, a write operation is performed on a cell disposed on a first line.

Further, a data pulse is grounded via the first switching elements 211-2 to 211-n of the scan derivers 210-2 to 210-n corresponding to the other scan electrodes Y2 to Yn and the ground switching element 230.

When this procedure is performed on every electrode, the scanning procedure is finished.

After the scanning procedure, a first sustain switching element 240, the second switching elements 213-1 to 213-n of the scan drivers 210-1 to 210-n and a ground switching element 260 are turned on.

Accordingly, a first sustain voltage +Vsy, the first sustain switching element 240, the second switching elements 213-1 to 213-n of the scan drivers 210-1 to 210-n, the scan electrodes Y1 to Yn, sustain electrodes Z1 to Zn, and the ground switching element 260 form a loop, thereby applying the sustain voltage +Vsy to the scan electrodes Y1 to Yn.

Next, a second sustain switching element 250, the first switching elements 211 to 211n of the scan drivers 210-1 to 210-n, and the ground switching element 230 are turned on.

Accordingly, a second sustain voltage +Vsz, sustain electrodes Z1 to Zn, the scan electrodes Y1 to Yn, the first switching elements 211-1 to 211-n of the scan drivers 210-1 to 210-n, and the ground switching element 230 form a loop, thereby applying the sustain voltage +Vsz to the sustain electrodes Z1 to Zn.

Such a driving apparatus of a plasma display panel applies a scan voltage −Vyscan and a data voltage +Vd or 0V to corresponding electrodes through a switching operation of the switching elements included in the scan drivers 210-1 to 210-n and data drivers IC 300-1 to 300-m in a scanning period. In this procedure, displacement current Id flows in the data drivers IC 300-1 to 300-n via the address electrodes.

Because a general plasma display panel has a three-electrode structure, as shown in FIG. 2, first equivalent capacitors Cm1 exist between the address electrodes, and second equivalent capacitors Cm2 exist between the address electrodes and the scan electrodes or sustain electrodes.

Therefore, the state of a voltage applied to the electrodes changes according to the operation of the switching elements included in the scan drivers 210-1 to 210-n and data drivers C 300-1 to 300-m in the scanning procedure, thus the displacement current Id generated by the first equivalent capacitors Cm1 and the second equivalent capacitors Cm2 flows in the data drivers IC 300-1 to 300-m via the address electrodes.

The magnitude of the displacement current is expressed by the following mathematical formula 1.

[Mathematical Formula]
Id=C×(dv/dt)×f

Id represents the magnitude of displacement current flowing in one address electrode, C represents a capacitance between address electrodes and between address electrodes and scan electrodes or between address electrodes and sustain electrodes, dv/dt represents the rate of change in voltage with respect to time in one electrode, and f represents a number of times of change in voltage of one address electrode. Thus, the displacement current is proportional to C and f.

FIGS. 3a to 3c show patterns generating a large displacement current.

FIG. 3a shows a sub-pixel pattern, FIG. 3b shows a super-pixel pattern, and FIG. 3c shows an alternate pattern.

FIGS. 4a to 4c are waveform views of image data according to each of the patterns as shown in FIGS. 3a to 3c.

As shown in FIGS. 3a and 4a, in the sub-pixel pattern, respective sub-pixels are turned on and off alternately. Thus, a number of times of switching of the data drivers IC 300-1 to 300-m for applying a data voltage or ground level to the address electrodes is large, and displacement current is generated by the capacitors existing between the address electrodes and between the address electrodes and the scan electrodes or between the address electrodes and the sustain electrodes, thereby creating the largest displacement current by the above mathematical formula.

As shown in FIGS. 3b and 4b, the super-pixel pattern is a pattern in which respective pixels are turned on and off in a repetitive fashion in units of pixels. Since respective pixels are turned on and off in a repetitive fashion, the super pixel pattern has a small number of times of switching and a small capacitance between the electrodes as compared to the sub-pixel pattern, but displacement current is generated which is large enough to affect a driving portion of the plasma display panel.

As shown in FIGS. 3c and 4c, the alternate pattern is a pattern in which respective pixels are turned on and off in a repetitive fashion in units of lines. Since respective pixels are turned on and off in a repetitive fashion, the alternate pattern has a small number of times of switching and a small capacitance between the electrodes as compared to the other patterns, but a peak current is applied to the sustain electrodes to affect a driving portion of the plasma display panel.

The displacement current thus generated has a big risk of damaging the driving portion of the plasma display panel due to its magnitude. Besides, the switching elements of the driving portion of the plasma display panel that can endure a large displacement current is expensive, thereby creating a problem of an increase in manufacturing cost.

### SUMMARY OF THE INVENTION

Accordingly, it is an object of the present invention to solve at least the problems and disadvantages of the background art.

It is an object of the present invention to provide a plasma display apparatus, which can reduce the magnitude of displacement current by detecting the data load of input image data, and a method of driving a plasma display panel.

According to a first aspect of the present invention, there is provided a plasmas display apparatus, comprising: a load calculator for calculating the data load of image data to be input to a plasma display panel from outside; and a gain controller for controlling the gain of image data according to the data load of image data calculated by the load calculator.

According to the first aspect of the present invention, there is provided a method of driving a plasma display panel which displays images by processing image data input from outside, wherein the gain of image data is controlled according to the data load of image data.

According to a second aspect of the present invention, there is provided a plasma display apparatus, comprising: a memory unit for storing image data input to a plasma display panel from outside; and a gray scale control unit for controlling a gray scale displayed by the image data if the image data of the memory unit is turned off in two or more adjacent cells in a repetitive pattern.

According to the second aspect of the present invention, there is provided a method of driving a plasma display panel which displays images by processing image data input from outside, wherein a gray scale displayed by the image data is controlled if the image data is turned off in two or more adjacent cells in a repetitive pattern.

According to a third aspect of the present invention, there is provided a plasmas display apparatus, comprising: a load calculator for calculating the data load of image data to be input to a plasma display panel from outside; and a light intensity controller for controlling the light intensity of the image data according to the data load of image data calculated by the load calculator.

In the present invention, a driving unit can be prevented from damage by reducing the magnitude of displacement current by controlling the gain according to the data load of image data.

### BRIEF DESCRIPTION OF THE DRAWINGS

The invention will be described din detail with reference to the following drawings in which like numerals refer to like elements.

FIG. 1 is a perspective view showing a structure of a general plasma display panel;

FIG. 2 is a simple circuit diagram of a driving apparatus of the general plasma display panel;

FIGS. 3a to 3c show patterns generating a large displacement current;

FIGS. 4ato 4c are waveform views of image data according to each of the patterns as shown in FIGS. 3a to 3c;

FIG. 5 is a view showing the construction of a first embodiment of a plasma display apparatus according to the present invention;

FIG. 6 is a view showing the construction of a second embodiment of the plasma display apparatus according to the present invention; and

FIG. 7 is a view showing the construction of a second embodiment of the plasma display apparatus according to the present invention.

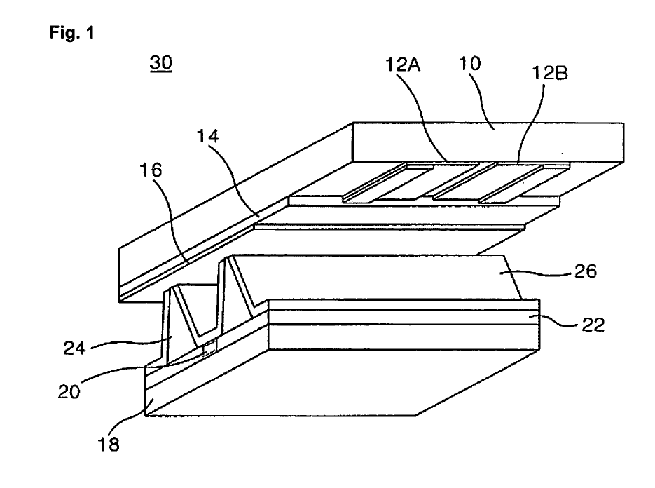

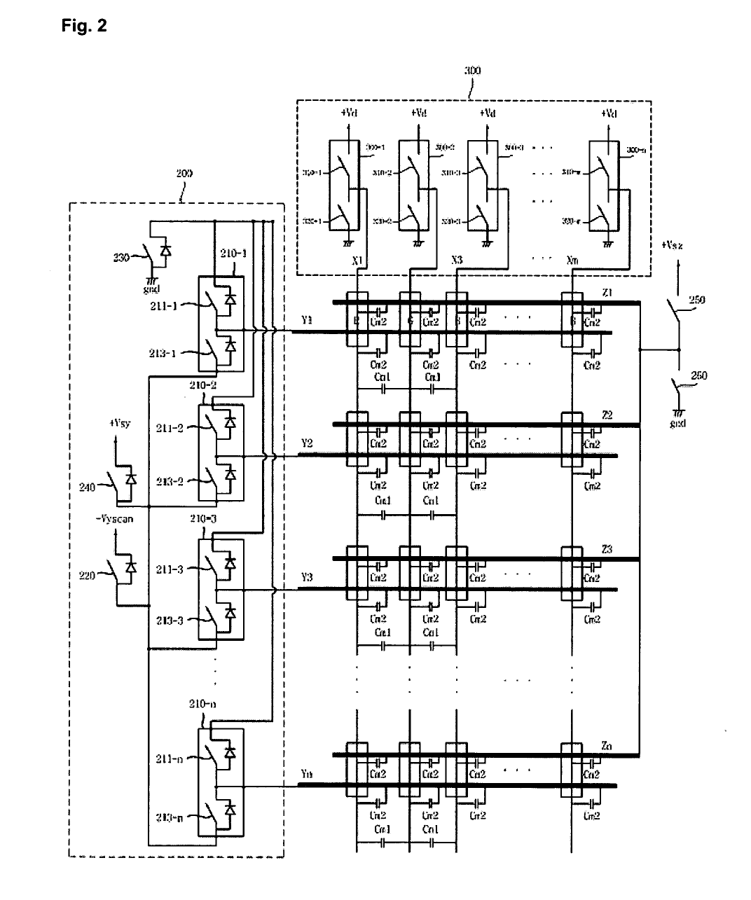

### DETAILED DESCRIPTION OF THE PREFERRED EMBODIMENTS

Preferred embodiments of the present invention will be described in a more detailed manner with reference to the drawings.

In a method of driving a plasma display panel which displays images by processing image data input from outside according to a first embodiment of the present invention, the gain of image data is controlled according to the data load of image data.

Furthermore, a load calculator calculates the total data load of image data by summing up a horizontal data load of the plasma display panel for image data and a vertical data load of the plasma display panel for image data, and the gain controller controls the gain of image data according to the total data load.

Furthermore, the gain controller makes the gain of image data in a second load smaller than the gain of image data in a first load if the data load of image data calculated by the load calculator is the second load larger than the first load.

Furthermore, the gain controller decreases the gain of image data as the data load of image data calculated by the load calculator increases.

Furthermore, the gain controller decreases the gain of image data if the data load of image data calculated by the load calculator is a critical load.

Furthermore, the critical load includes a first critical load and a second critical load larger than the first critical load, and the magnitude of the gain of image data that decreases at a load higher than the first critical load and the magnitude of the gain of image data that decreases at a load higher than the second critical load are the same.

A plasma display apparatus according to a second embodiment of the present invention comprises: a memory unit for storing image data input to a plasma display panel from outside; and a gray scale control unit for controlling a gray scale displayed by the image data if the image data of the memory unit is turned off in two or more adjacent cells in a repetitive pattern.

Furthermore, the gray scale control unit decreases a gray scale displayed by the image data if the image data is turned off in two or more adjacent cells in a repetitive pattern.

Furthermore, the pattern in which the image data is turned off in two or more adjacent cells repetitively is a pattern in which two or more adjacent cells to which a different scan pulse is applied are turned off repetitively.

A plasma display apparatus according to a third embodiment of the present invention comprises: a load calculator for calculating the data load of image data to be input to a plasma display panel from outside; and a light intensity controller for controlling the light intensity of the image data according to the data load of image data calculated by the load calculator.

In a method of driving a plasma display panel which displays images by processing image data input from outside according to the first embodiment of the present invention, the gain of image data is controlled according to the data load of image data.

Furthermore, the data load is a sum of a horizontal data load of the plasma display panel for the image data and a vertical data load of the plasma display panel for the image data.

Furthermore, the gain of the image data in a second load is smaller than the gain of image data in a first load if the data load of the image data calculated by the load calculator is the second load larger than the first load.

Furthermore, the gain of the image data decreases as the data load of the image data calculated by the load calculator increases.

Furthermore, the gain of the image data decreases if the data load of the image data calculated by the load calculator is higher than a critical load.

Furthermore, the critical load includes a first critical load and a second critical load larger than the first critical load, and the magnitude of the gain of image data that decreases at a load higher than the first critical load and the magnitude of the gain of image data that decreases at a load higher than the second critical load are the same.

In a method of driving a plasma display panel which displays images by processing image data input from outside according to the second embodiment of the present invention, a gray scale displayed by the image data is controlled if the image data is turned off in two or more adjacent cells in a repetitive pattern.

Furthermore, a gray scale displayed by the image data decreases if two or more cells adjacent to the image data are turned off repetitively.

Furthermore, the pattern in which the image data is turned off in two or more adjacent cells in a repetitive pattern is a pattern in which the image data is turned off in two or more cells to which a different pulse is applied.

Hereinafter, preferred embodiments of the present invention will be described in detail with reference to the accompanying drawings.

### First Embodiment

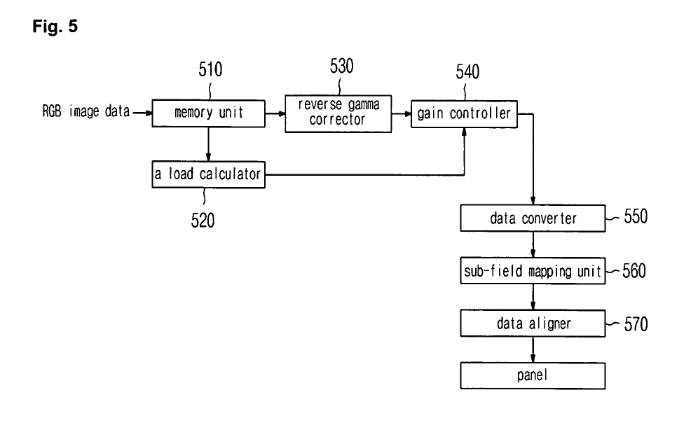

FIG. 5 is a view showing the construction of a first embodiment of a plasma display apparatus according to the present invention.

As shown in FIG. 5, the first embodiment of the plasma display apparatus according to the present invention comprises a memory unit 510, a load calculator 520, a reverse gamma corrector 530, a gain controller 540, a data converter 550, a sub-field mapping unit 560, and a data aligner 570.

<Memory Unit>

The memory unit 510 stores red(R),green(G), blue(B) image data.

<Load Calculator>

The load calculator 520 calculates the load of image data utilizing R,G,B image data stored in the memory unit 510.

The load calculator 520 according to the present invention calculates the total data load by counting a number of times of data switching between discharge cells according to the image data stored in the memory unit 510.

The load calculator 520 calculates the total data load of the image data by summing up a horizontal data load of the plasma display panel for the image data and a vertical data load of the plasma display panel for the image data.

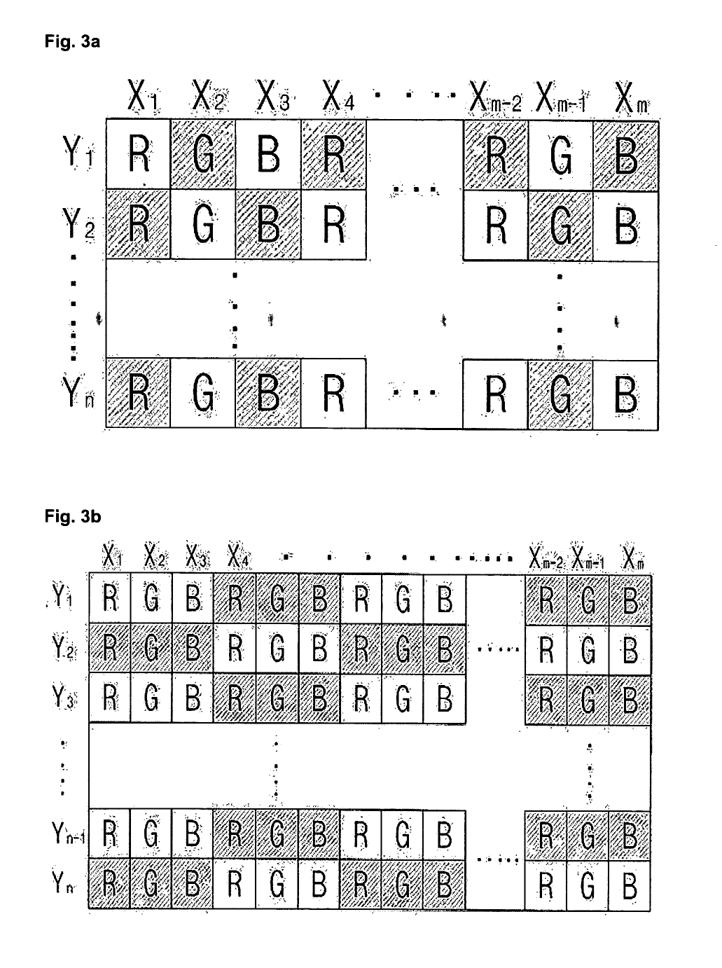

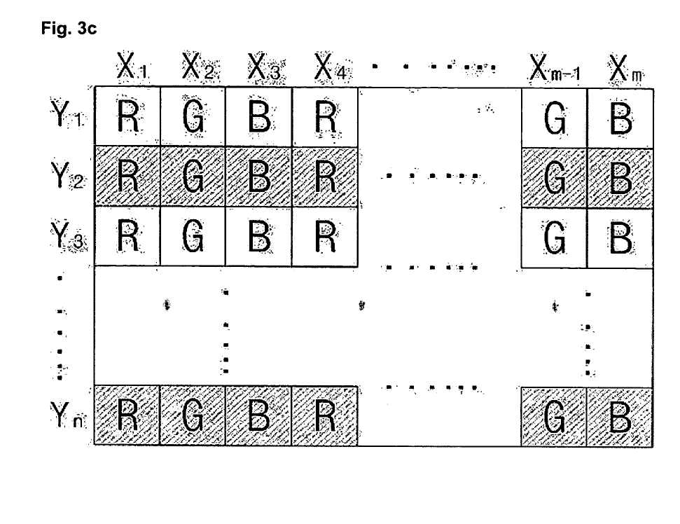

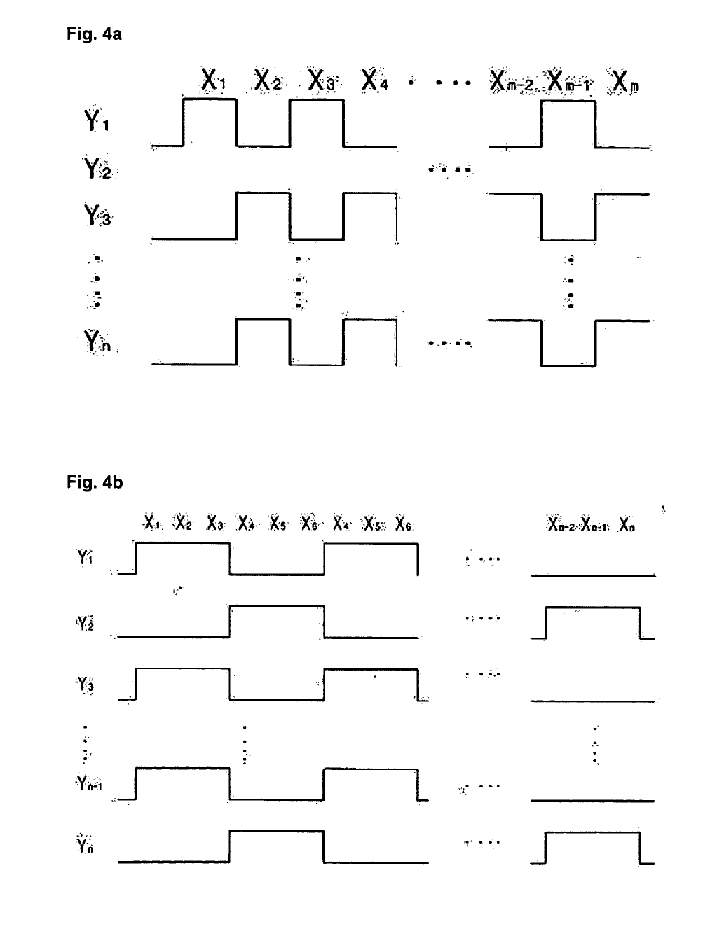

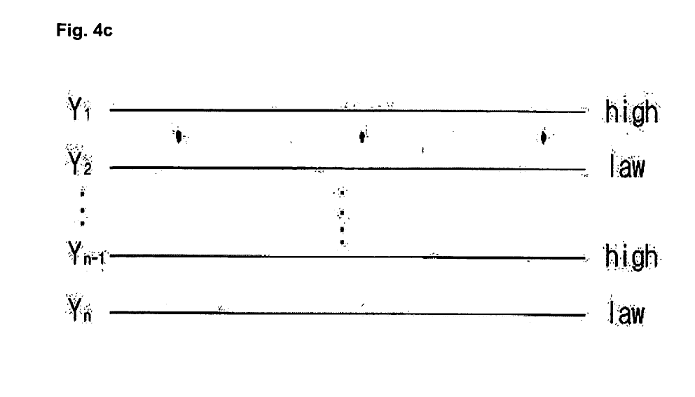

For example, in a case that image data as shown in FIG. 3 is supplied, the load calculator 520 counts a number of times of data switching in a horizontal direction of the plasma display panel, that is, a number of times of switching on and off the data in the order of R, G, B, R, G and B. Further, the load calculator 520 counts a number of times of data switching in the vertical direction of the plasma display panel, that is, a number of times of switching on and off data between discharge cells of the same kind, for instance, a number of times of data switching between R discharge cells.

In the case as shown in FIG. 3a, if it is assumed that a number of times of data switching in a horizontal direction of the plasma display panel is 100, a number of times of data switching in a vertical direction of the plasma display panel is 50, a load of one-time switching in a horizontal direction is A, and a load of one-time switching in a vertical direction is B, the load calculator 520 calculates and outputs a data load value of 100A+50B.

Further, in the case that image data is supplied as shown in FIG. 3b, a number of data switching counted by the load calculator 520 is smaller than that in the case of FIG. 3a. That is, in case of the image data of FIG. 3b, a number of times of data switching in a vertical direction of the plasma display panel is the same and a number of times of switching in a horizontal direction is reduced, as compared to FIG. 3a. Thus, the value of the data load calculated b the load calculator 520 decreases as much as the number of times of switching in the horizontal direction decreases.

Further, in the case that image data is supplied as shown in FIG. 3c, a number of data switching counted by the load calculator 520 is smaller than that in the case of FIG. 3b. That is, in case of the image data of FIG. 3c, a number of times of data switching in a vertical direction of the plasma display panel is the same and a number of times of switching in a horizontal direction is reduced to 0, as compared to FIG. 3b. Thus, the value of the data load calculated b the load calculator 520 decreases as much as the number of times of switching in the horizontal direction decreases.

<Reverse Gamma Corrector>

The reverse gamma corrector 530 performs a reverse gamma correction for acquiring gray scale linearity for R, G, B image data stored in the memory unit 510.

<Gain Controller>

The gain controller 540 controls gains of the image data according to the above-mentioned data load value calculated by the load calculator 520 for the R, G, B image data outputted from the reverse gamma corrector 530.

The gain controller 540 controls gains so that gains of the image data in a second load is smaller than gains of the image data in a first load if the data load of the image data calculated by the load calculator 520 is the second load larger than the first load.

Preferably, the gain controller 540 decreases gains of the image data as the data load of the image data calculated by the load calculator 520 increases.

Alternatively, it is also preferable to decrease gains of the image data if the data load of the image data calculated by the load calculator 520 is higher than a critical load, under the condition that the critical load is preset.

Moreover, it is also possible for the gain controller 540 to control gains by setting the critical load as two or more values. For instance, the gain controller 540 sets the critical load as a first critical load and a second critical load larger than the first critical load. And, if the image data calculated by the load calculator 420 exceeds the first critical load, the gain of the image data is reduced. Also, if the image data calculated by the load calculator 520 exceeds the second critical load, the gain of the image data is reduced to a degree of gain reduction larger than the degree of gain reduction applied when the first critical load is exceeded as above. That is, if it is assumed that when the image data exceeds the first critical load, the gain is reduced by 0.1, the gain is reduced by 0.2 when the image data exceeds the second critical load. Here, the degree of the gain reduction for each critical load is the same.

<Data Converter>

The data converter 550 performs error diffusion and dithering in order to convert gain controlled image data into data suitable for a plasma display panel.

<Sub-Field Mapping Unit>

The sub-field mapping unit 560 maps sub-fields according to the image data converted by the data converter 550.

The operation of the plasma display apparatus of this invention will be described. If a gray scale value of image data outputted by the reverse gamma corrector 530 is 255 and the data load of the image data outputted by the reverse gamma corrector 530 exceeds a critical load, the load calculator 520 calculates the data load and outputs the result to the gain controller 540.

Then, the gain controller 540 controls gains of the image data. For instance, if a gain control amount is 0.4, the final gray scale value becomes 102 (=255*0.4), thus the sub-filed mapping unit 560 maps sub-fields for the final gray scale value 102.

Therefore, since a number of sub-fields mapped for 102 is smaller than a number of sub-fields mapped for 255, the magnitude of a displacement current according to a severity pattern. In other words, the smaller the number of sub-fields, the less the number of times of switching of switching elements included in a driving unit for driving the plasma display panel, and thus the magnitude of the displacement current becomes smaller, Accordingly, it is possible to prevent electrical damage of the driving unit.

Unlike the first embodiment of the plasma display apparatus of this invention, the gray scales of an image displayed by image data can be controlled according to the image pattern of input image data, which is like the second embodiment of the plasma display apparatus of this invention.

### Second Embodiment

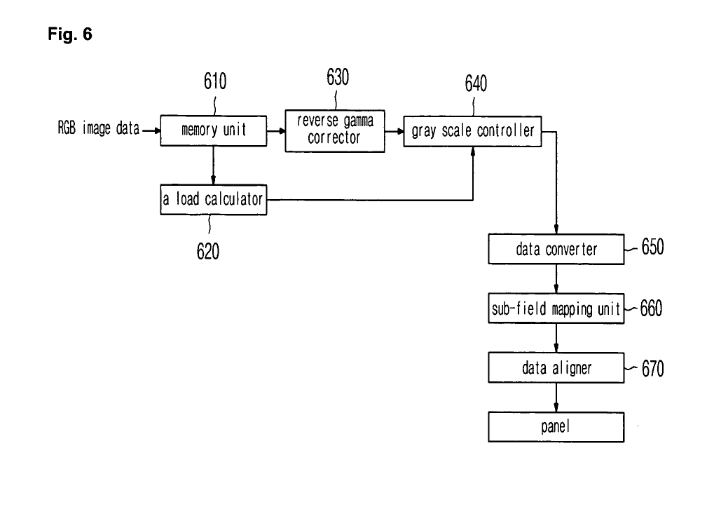

FIG. 6 is a view showing the construction of a second embodiment of the plasma display apparatus according to the present invention.

As shown in FIG. 6, the second embodiment of the plasma display apparatus according to the present invention comprises a memory unit 610, a pattern recognizer 620, a reverse gamma corrector 630, a gray scale controller 640, a data converter 650, a sub-field mapping unit 660, and a data aligner 670.

The second embodiment of the plasma display apparatus of the present invention is identical to the first embodiment, except with respect to the pattern recognizer of reference numeral 620 and the gray scale controller of reference numeral 640, and therefore, repetitive description thereof is omitted here.

<Pattern Recognizer>

The pattern recognizer 620 determines if image data stored in the above-mentioned memory unit 610 is turned off in two or more adjacent cells in a repetitive pattern. More concretely, as shown in FIGS. 3a to 3c, if the image data stored in the above-mentioned memory unit 610 is turned off in a repetitive pattern in two or more adjacent cells to which a different scan pulse is applied, the pattern recognizer 620 determines that the image data is turned off in two or more adjacent cells in a repetitive pattern.

<Gray Scale Controller>

The gray scale controller 640 controls the gray scale of an image displayed by image data according to the image pattern of the image data determined by the pattern recognizer 620. More preferably, if the image data supplied to the plasma display panel is turned off in two or more adjacent cells in a repetitive pattern, the gray scale controller 640 reduces the gray scale displayed by the image data.

In other words, in the second embodiment of the plasma display apparatus of the present invention, the gray scale of an image displayed by image data according to the image pattern of the input image data.

In the second embodiment of the plasma display apparatus of this invention, if the image pattern of input image data is a pattern in which the image data is turned off repetitively in two or more adjacent cells, gray scales displayed in the image data are reduced, thereby reducing a number of times of supplying data to be supplied to one cell in one frame, whereby a number of times of switching for supplying data is reduced. Resultantly, electrical damage of the driving unit can be prevented.

Unlike the first and second embodiments of the plasma display apparatus of this invention, the light intensity of an image displayed can be controlled according to the data load of image data, which is like the third embodiment of the plasma display apparatus of this invention.

### Third Embodiment

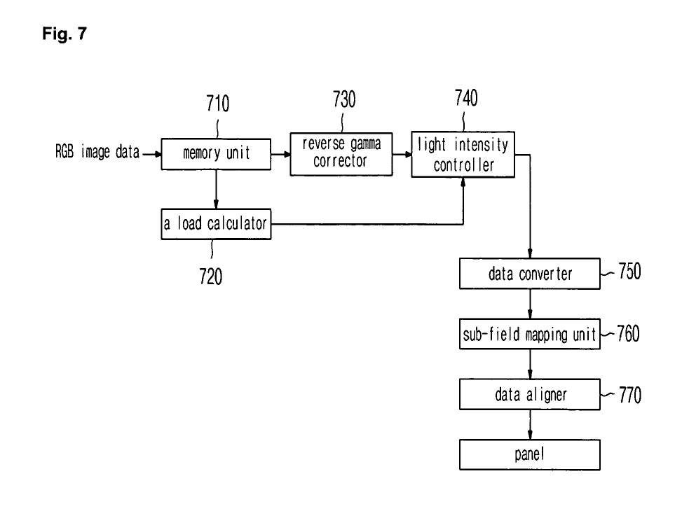

FIG. 7 is a view showing the construction of a third embodiment of the plasma display apparatus according to the present invention.

As shown in FIG. 7, the third embodiment of the plasma display apparatus according to the present invention comprises a memory unit 710, a pattern recognizer 720, a reverse gamma corrector 730, a light intensity controller 740, a data converter 750, a sub-field mapping unit 760, and a data aligner 770.

The third embodiment of the plasma display apparatus of the present invention is identical to the first embodiment, except with respect to the light intensity controller of reference numeral 740, and therefore, repetitive description thereof is omitted here.

That is, in the third embodiment of the plasma display apparatus of this invention, the light intensity of an image displayed can be controlled according to the data load of image data. For instance, if the data load of input image data exceeds a critical load, the light intensity controller of reference numeral 740 controls the light intensity of a displayed image to be reduced. Alternatively, if the data load of input image data increases, it controls the light intensity of a displayed image to be continuously reduced.

The operation of the third embodiment of the plasma display apparatus of this invention will be described. If the data load of an image data outputted by the reverse gamma corrector 730 exceeds a critical load, the load calculator 720 calculates the data load and outputs the result to the gain controller 740.

Then, the light intensity controller 740 reduces the light intensity of the image data displayed on a screen by the image data.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus, comprising:
a plasma display panel including a plurality of scan electrodes and a plurality of address electrodes formed to intersect the scan electrodes;
a load calculator for calculating the data load of image data input into the plasma display panel from outside; and
a gain controller for controlling gains of the image data according to the data load of the image data calculated by the load calculator.

2. The plasma display apparatus of claim 1, wherein the load calculator calculates the total data load of image data by summing up a horizontal data load of the plasma display panel for image data and a vertical data load of the plasma display panel for image data, and
the gain controller controls the gain of image data according to the total data load.

3. The plasma display apparatus of claim 2, wherein the gain controller makes the gain of image data in a second load smaller than the gain of image data in a first load if the data load of image data calculated by the load calculator is the second load larger than the first load.

4. The plasma display apparatus of claim 3, wherein, the gain controller decreases the gain of image data as the data load of image data calculated by the load calculator increases.

5. The plasma display apparatus of claim 3, wherein, the gain controller decreases the gain of image data if the data load of image data calculated by the load calculator is a critical load.

6. The plasma display apparatus of claim 5, wherein the critical load includes a first critical load and a second critical load larger than the first critical load, and
the magnitude of the gain of image data that decreases at a load higher than the first critical load and the magnitude of the gain of image data that decreases at a load higher than the second critical load are the same.

7. A plasma display apparatus, comprising:
a memory unit for storing image data input to a plasma display panel from outside; and
a gray scale control unit for controlling a gray scale displayed by the image data if the image data of the memory unit is turned on and turned off in two or more adjacent cells in a repetitive pattern.

8. The plasma display panel of claim 7, wherein if the image data supplied to the plasma display panel is turned on and turned off in two or more adjacent cells in a repetitive pattern, the gray scale controller reduces the gray scale displayed by the image data.

9. The plasma display panel of claim 7, wherein the pattern in which the image data is turn on and turned off in two or more adjacent cells repetitively is a pattern in which two or more adjacent cells to which a different scan pulse is applied are turned on and turned off repetitively.

10. A method of driving a plasma display panel which displays images by processing image data input from outside, wherein the gain of image data is controlled according to the data load of image data.

11. The method of claim 8, wherein the data load is a sum of a horizontal data load of the plasma display panel for the image data and a vertical data load of the plasma display panel for the image data.

12. The method of claim 9, wherein the gain of the image data in a second load is smaller than the gain of image data in a first load if the data load of the image data calculated by the load calculator is the second load larger than the first load.

13. The method of claim 10, wherein the gain of the image data decreases as the data load of the image data calculated by the load calculator increases.

14. The method of claim 12, wherein the gain of the image data decreases if the data load of the image data calculated by the load calculator is higher than a critical load.

15. The method of claim 12, wherein the critical load includes a first critical load and a second critical load larger than the first critical load, and the magnitude of the gain of image data that decreases at a load higher than the first critical load and the magnitude of the gain of image data that decreases at a load higher than the second critical load are the same.

16. A method of driving a plasma display panel which displays images by processing image data input from outside, wherein a gray scale displayed by the image data is controlled if the image data is turned on and turned off in two or more adjacent cells in a repetitive pattern.

17. The method of claim 14, wherein a gray scale displayed by the image data decreases if two or more cells adjacent to the image data are turned on and turned off repetitively.

18. The method of claim 14, wherein the pattern in which the image data is turned on and turned off in two or more adjacent cells in a repetitive pattern is a pattern in which the image data is turned on and turned off in two or more cells to which a different scan pulse is applied.
